(19) United States
(12) Patent Application Publication
(10) Pub. No.: US 2021/0166247 A1
(43) Pub. Date: Jun. 3, 2021

(54) ASSET OWNERSHIP TRANSFER AND VERIFICATION MANAGEMENT

(71) Applicant: Hewlett-Packard Development Company, L.P., Spring, TX (US)

(72) Inventors: Sekhar Muni Sirigiri, Banaglore (IN); Nandan Kumar Nidhi, Bangalore (IN)

(21) Appl. No.: 17/047,660

(22) PCT Filed: Apr. 9, 2019
(86) PCT No.: PCT/US2019/026447

§ 371 Date: Oct. 14, 2020

(30) Foreign Application Priority Data
Jun. 8, 2018 (IN) 201841021616

(51) Int. Cl. G06Q 30/00; G06F 16/27; H04L 9/30; H04L 9/32

(52) U.S. Cl. CPC G06Q 30/018; G06F 16/27; G06Q 2220/10; H04L 9/321; H04L 9/30

(57) ABSTRACT

A second user device of a second user, a prospective second owner of an asset owned by a first user, may receive an ownership verification message and a first user digital address of a first ownership transaction, from a first user device of the first user, to authenticate first users ownership of the asset. The first ownership transaction is created in a public ledger. Upon verification of the ownership, the second user device performs a second transfer initiation action and encodes a second fingerprint to obtain an encoded second fingerprint. The second fingerprint is obtained from a second ownership document indicating a transfer of ownership of the asset to the second user. The first user device creates the second ownership transaction using a second ownership locking script having a public key of the second user and the encoded second fingerprint.

### BACKGROUND

Ownership transfer and verification of an asset, such as a physical or a digital property, has traditionally been managed using a physical hard copy of an ownership document. The ownership document is used as a proof of ownership of the asset. In case of a transfer of ownership of the asset, a new customer may use an existing ownership document to verify ownership rights of an existing owner. Additionally, the new owner may physically visit a government organization, such as a registrar, to get the existing ownership documents verified and a new ownership document registered, making the ownership transfer and verification process a cumbersome and time-consuming process.

### BRIEF DESCRIPTION OF DRAWINGS

The detailed description is described with reference to the accompanying figures. It should be noted that the description and figures are merely example of the present subject matter and are not meant to represent the subject matter itself.

FIG. 1 illustrates a block diagram of a system for asset ownership transfer and verification management, according to an example of the present subject matter.

FIG. 2 illustrates a network environment implementation of the system for asset ownership transfer and verification management using a public ledger, according to an example of the present subject matter.

FIG. 3 illustrates a block diagram of the system in communication with a public ledger network for asset ownership transfer and verification management, according to another example of the present subject matter.

FIG. 4 illustrates a method of asset ownership transfer and verification management, according to an example of the present subject matter.

FIG. 5 illustrates a method of asset ownership transfer and verification management, according to another example of the present subject matter.

FIG. 6 illustrates a method of asset ownership transfer and verification management, according to another example of the present subject matter.

FIG. 7 illustrates a network environment implementing a non-transitory computer readable medium for asset ownership transfer and verification management, according to an example of the present subject matter.

### DETAILED DESCRIPTION

The subject matter relates to managing ownership transfer and verification of an asset, such as a physical or a digital property. A physical hard copy of an ownership document has traditionally been used as a proof of ownership of an asset. In case of a transfer of ownership of the asset, a new ownership document is generated and handed to a new owner of the asset as a proof of ownership. Further, to keep a track of asset ownership and ownership transfer since asset creation, the new owner may also be provided ownership documents of previous owners, making it cumbersome to handle the documents. Further, a verification of the ownership documents may be performed by centralized authorities or regulators to whom either the ownership documents may be physically provided or requested to be retrieved from their archives, making the verification process a cumbersome and time-consuming process.

In recent years, digital storage and verification of ownership documents has become popular for transfer and verification of ownership documents. Techniques for the digital storage and verification of ownership documents involve using digital fingerprints of the asset for representing the asset in a public ledger. To transfer ownership, the new owner may either perform a transfer transaction on a first public ledger managing tokens or make a physical transaction. A current owner of the asset may then initiate ownership transfer on the public ledger used for managing the asset by creating a new transfer record as a proof of ownership. Further, a verification of the ownership may be performed by the new owner using digital signatures and encryption keys of the current owner of the asset. Additionally, network nodes of the public ledger may also validate the ownership to validate the transfer record. The technique may thus remove dependency of ownership validation and transfer on physical documentations. However, since digital records and transfers are always exposed to cyber threats, a complete removal of physical ownership document and centralized authorities or regulators may not be suggested. For instance, a third party that may gain access to encryption keys of the current owner may obtain ownership of the assets. Additionally, any anomaly in the network nodes may result in an incorrect rejection or approval of a transfer record. Further, using different public ledgers for managing asset ownership and transfer transactions may result in inconvenience in tracking and verification of transactions.

The present subject matter discloses example implementations of techniques for asset ownership transfer and verification management using public ledgers, such as a blockchain. In one example implementation, ownership verification and transfer of an asset managed by an asset regulator may be managed using digital and physical representations of an asset ownership document. The asset regulator may be a government or a private organization or authority managing the asset registered with the public ledger. For example, in case of the asset being a vehicle, the asset regulator may be a manufacturer of the vehicle or a dealer. In another example, for the asset being a real estate property, the asset regulator may be a builder of the property or a housing complex in which the property is situated.

In said example, an asset may be represented in a public ledger using an asset ID and a fingerprint of the asset ownership document may be used to represent the ownership of the asset. To manage the asset transfer, the asset regulator may register the asset ID with the public ledger by performing a genesis transaction in the public ledger. The genesis transaction may include an encoded asset ID to indicate the asset for which the genesis transaction is performed in the public ledger. Once the genesis, transaction is created, a digital transaction manager of an asset management device of the asset regulator may inform the network nodes of a public ledger network having the public ledger, for adding the genesis transaction in the public ledger and verifying the genesis transaction.

Subsequently, when a first user intends to obtain the asset from the asset regulator, the first user may initially perform a verification of the asset regulators ownership of the asset by verifying a digital address of the genesis transaction in the public ledger. The first user may then perform a first transfer initiation action using an instance of the digital transaction manager on a first user device. The asset regulator may then generate, using a print device, a first ownership document indicating transfer of ownership of the asset to the first user. The asset regulator may further generate a first fingerprint of the first ownership document, using a fingerprint generator, such that the first fingerprint may include the asset ID to indicate the relationship between the first fingerprint and the asset. The asset management device may then use a first ownership locking script for creating a first ownership transaction to complete the ownership transfer. The first ownership locking script may be generated by the first user and may include a public key of the first user and an encoded first fingerprint. Once the first ownership transaction is created, the asset management device may inform the network nodes of the public ledger network for adding the first ownership transaction in the public ledger after a public ledger verification.

In case a second user intends to obtain the asset from the first user, the second user may perform a verification of the first user's ownership of the asset by verifying a first user digital address of the first ownership transaction in the public ledger. Upon verification, the second user may perform a second transfer initiation action using another instance of digital transaction manager on a second user device. The first user may then use a second ownership locking script, generated by the second user, for creating the second ownership transaction to complete the ownership transfer. The digital transaction manager may subsequently inform the network nodes of the public ledger network for adding the second ownership transaction in the public ledger. Further, in one example, the asset regulator may generate a second ownership document indicating the second user as the owner of the asset, and generate a second fingerprint from the second ownership document. In another example, the first user may transfer the first ownership document and the first fingerprint to the second user for transfer of the asset.

The present subject matter thus describes asset ownership transfer and verification management using a combination of public ledger and physical ownership documents. Verifying the ownership rights of a user based on the digital address of the ownership transaction created in the public ledger and completing the ownership transfer using the fingerprint of the ownership documents helps in securing an authorized transfer as the user's ownership of the asset is verified using two different methods and sources. Additionally, having a new ownership document and fingerprint generated for each ownership transaction may help in ensuring that any anomaly in the public ledger may be detected using the ownership document. Alternately, in case of a forgery of the ownership document, the fingerprint of the forged ownership document may not match the fingerprint stored in the public ledger, there by facilitating in detecting a forgery. Using the asset ID for representing the asset in the public ledger further helps in an authorized verification of the asset as the fingerprint shared with a new owner should refer to the same asset ID as the asset ID recorded in the genesis transaction to indicate an authorized transaction.

Further, since the same public ledger may be used for ownership transfer and verification and conduction token transactions, an authorized token transaction may be easily detected and verified by users and network nodes of the public ledger network. Further, the users may not have to use digital address in multiple public ledgers for a single ownership transfer transaction. The present subject matter further describes using an existing public ledger network, thereby, reducing costs involved in creating a new public ledger.

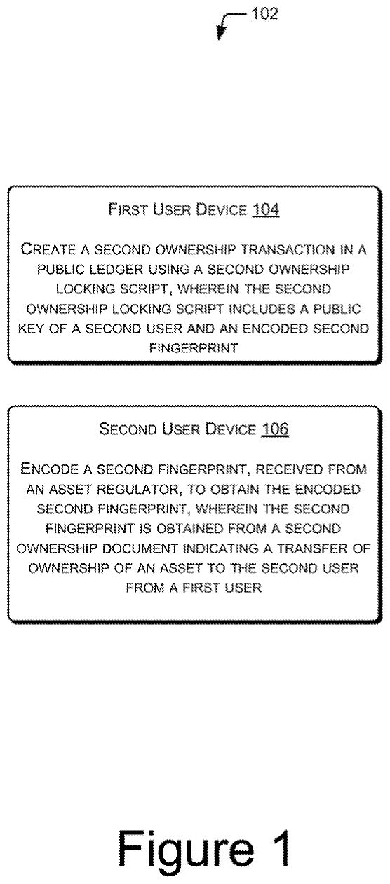

The present subject matter is further described with reference to FIGS. 1 to 7. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a block diagram of a system 102 for asset ownership transfer and verification management, according to an example of the present subject matter. In one example implementation of the present subject matter, the system 102 includes a first user device 104 of a first user and a second user device 106 of a second user communicatively connected to each other for verification and transfer of ownership of an asset managed by an asset regulator. In one example, the first user may be a first owner of the asset managed by the asset regulator. Further, the second user may be a prospective second owner of the asset owned by the first user. Examples of the first user device 104 and the second user device 106 include, but are not limited to, desktop computers, laptops, tablets, notebooks, personal digital assistances, cellular communication devices, phablets, portable computers, workstation, mainframe computer, servers, and network servers.

In accordance to an example implementation of the present subject matter, upon showing interest in obtaining ownership of the asset, the second user device 106 may receive an ownership verification message and a first user digital address of a first ownership transaction from the first user device 104. The first ownership transaction may be a transaction indicating transfer of ownership to the first user of the first user device 104. In one example, the first ownership transaction may be created in a public ledger for managing ownership verification and transfer. The public ledger, for example, a blockchain is a continuous list of linked and secured records managed by nodes of a public ledger network and may be used for recording transactions between different users.

The ownership verification message and the first user digital address of the first ownership transaction may be used by the second user device 106 to authenticate ownership of the asset by the first user. Upon verification of the ownership of the first user digital address and the asset, the second user device 106 may perform a second transfer initiation action for initiating transfer of ownership of the asset from the first user to the second user. In response to second transfer initiation action, the second user device 106 may receive a second fingerprint from the asset regulator of the asset. In one example, the second fingerprint may be obtained from a second ownership document indicating a transfer of ownership of the asset to the second user from the first user. The second user device 106 may then encode the second fingerprint to obtain an encoded second fingerprint.

The first user device 104 may subsequently create the second ownership transaction in the public ledger using a second ownership locking script In one example, the second ownership locking script may include a public key of the second user and the encoded second fingerprint.

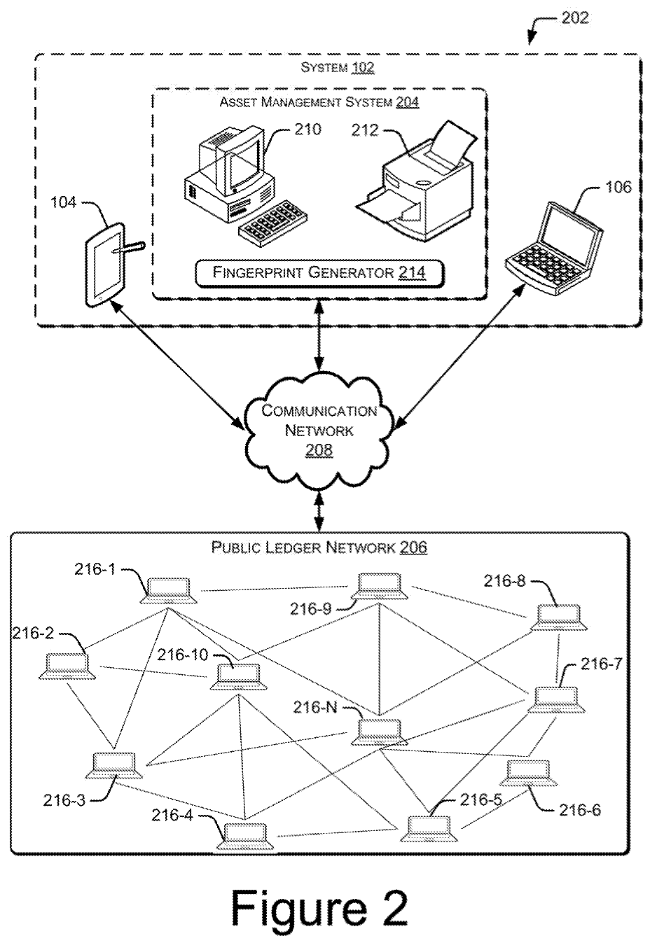

FIG. 2 illustrates a network environment implementation 202 having the system 102 for asset ownership transfer and verification management using a public ledger, according to an example of the present subject matter. In accordance with an example implementation of the present subject matter, the network environment implementation 202 includes the first user device 104, an asset management system 204, the second user device 106, and a public ledger network 206 in communication with each other over a communication network 208.

In accordance with an example implementation of the present subject matter, the asset management system 204 may include an asset management device 210, a print device 212, and a fingerprint generator 214. In accordance to another example implementation of the present subject matter, the asset management system 204 may include the asset management device 210. The print device 212 and the fingerprint generator 214 may be standalone devices communicatively coupled to the asset management device. Further, in on example, the fingerprint generator 214 may be integrated with either the asset management device 210 or the print device 212.

Examples of the first user device 104, the second user device 106, and the asset management device 210 include, but are not limited to, desktop computers, laptops, tablets, notebooks, personal digital assistances, cellular communication devices, phablets, portable computers, workstation, mainframe computer, servers, and network servers. Examples of the print device 212 include, but are not limited to, printers, multi-functional printers, scanners, etc. Examples of the fingerprint generator 214 include, but are not limited to, an imaging device, such as Dyson relay contact imaging device and a scanner.

The communication network 208 may be a wireless network, a wired network, or a combination thereof. The communication network 208 can also be an individual network or a collection of many such individual networks, interconnected with each other and functioning as a single large network, e.g., the Internet or an intranet. The communication network 208 can be one of the different types of networks, such as intranet, local area network (LAN), wide area network (WAN), and the Internet. In an example, the communication network 208 may include any communication network that uses any of the commonly used protocols, for example, Hypertext Transfer Protocol (HTTP), and Transmission Control Protocol/Internet Protocol (TCP/IP).

The public ledger network 206, may have a plurality of network nodes 216-1, 216-2, 216-3, 216-4, 216-5, 216-6, 216-7, 216-8, 216-9, 216-10, . . . , 216-N, hereinafter collectively referred to as network nodes 216 and individually as network node 216. The network nodes 216 may function as mining and validation nodes for adding and validating transactions in a public ledger managed by the public ledger network 206. The public ledger, for example, a blockchain may be a continuous list of linked and secured records managed by network nodes 216 and may be used for recording transactions between different users. In one example, the public ledger network 206 may be a peer-to-peer network. In another example, the public ledger network 206 may be a distributed network.

In one example implementation of the present subject matter, the system 102 may be implemented for asset ownership transfer and verification management of an asset managed by an asset regulator. The asset regulator may be a government or a private organization or authority managing the asset registered with the public ledger. In one example, the asset regulator may be a creator or manufacturer of the asset. In another example, the asset regulator may be an agency managing the asset manufactured or created by a third party. For example, the asset regulator may be a manufacturer of a vehicle, a builder of a real estate property, a dealer selling the vehicle or the real estate property, a housing complex in which the property is situated, a government body managing and regularizing transactions related to digital or physical assets.

In one example, the asset regulator may use the asset management system 204 to manage the ownership transfer and verification of the asset. The asset management system 204, for example, may register the asset with the public ledger; manage ownership transfer to a first owner; say, the first user; verify, for a perspective second owner, ownership of the asset by the first owner; and provide ownership transfer documents for an owner of the asset.

In operation, to register the asset with the public ledger, the asset management device 210 of the asset management system 204 may initially generate an asset ID for digital identification of the asset. In one example, the asset management device 210 may include an asset ID generator for generating the asset ID. In another example, the asset management device 210 may obtain the asset ID from the asset ID generator implemented on a server or a computing system outside the asset management system. The asset ID, in one example, may be an alphanumeric code unique to the asset for which the asset ID is generated. For example, the asset ID may be a chassis number of a vehicle, an address of a real estate property, a government registered number, etc.

The asset management device 210 may subsequently perform a genesis transaction in the public ledger to register the asset, using an encoded asset ID to indicate the asset for which the genesis transaction is performed in the public ledger. In one example, the asset management device 210 may initially perform an initiating transaction by transferring a token from a first digital address of the asset regulator to a second digital address of the asset regulator. The token may be a transaction token recognized by the public ledger network for being used for conducting transactions between two users. The asset management device 210 may then record the encoded asset ID in the public ledger to perform the genesis transaction. The asset management device 210 may further unlock the initiating transaction and create the genesis transaction using a locking script at a digital address associated with the asset regulator. In one example, the locking script may include the encoded asset ID and a public key of the asset regulator. Further, the genesis transaction may include the encoded asset ID as a proof of existence of the asset for the genesis transaction.

Once the genesis transaction is created, the asset management device may inform the network nodes 216 of the public ledger network 206 for verifying the genesis transaction and adding the genesis transaction in the public ledger. The asset may thus be made available on the public ledger for possession by an interested user An interested user, say, the first user may then initiate communication and ownership transfer transactions with the asset regulator over the communication network 208. In one example, the first user may initially perform, using the first user device 104 a verification of the asset regulator's ownership of the asset by verifying a digital address of the genesis transaction in the public ledger. The first user device 104 may initially send an encrypted verification request to the asset management device 210. The asset management device 210, may receive the encrypted verification request, decrypt the encrypted verification request, in response, transmit an asset ownership verification message and the digital address of the genesis transaction to the first user device 104

The first user may then verify the asset ownership using the asset ownership verification message and the digital address as shared by the asset regulator. The first user device 104 may then perform a first transfer initiation action to initiate ownership transfer from the asset regulator. Upon confirming the first transfer initiation action, the asset management device 210 may obtain a first ownership document indicating transfer of ownership of the asset to the first user and a first fingerprint of the asset for registering the ownership transfer. In one example, the print device 212 may generate the first ownership document and the fingerprint generator 214 may generate the first fingerprint using the first ownership document. In one example, the fingerprint generator 214 may generate the first fingerprint using a portion of the first ownership document. In another example, the fingerprint generator 214 may generate the first fingerprint using an entire first ownership document.

In one example implementation, the first fingerprint may include the asset ID to indicate the relationship between the first fingerprint and the asset. The asset management device 210 may then share an encrypted first fingerprint with the first user device 104 to transfer the ownership The first user device 104 may decrypt the encrypted first fingerprint to obtain the first fingerprint and generate a first ownership locking script. In one example, first ownership locking script may include a public key of the first user and an encoded first fingerprint. The asset management device 210 may then use the first ownership locking script for creating a first ownership transaction to complete the ownership transfer. Further, the asset management device may communicate the ownership transfer to the network nodes 216 for verifying and adding the first ownership transaction in the public ledger.

Subsequently, when the second user intends to obtain the asset from the first user, the second user may perform a verification of the first user's ownership of the asset. The second user, using the second user device 106, may transmit an encrypted verification request message to the first user device 104 to request the verification of the asset ownership. The first user device 104, may receive the encrypted verification request message, decrypt the encrypted verification request message, and transmit an ownership verification message and the digital address of the first ownership transaction to the second, user device 106. Upon verification, the second user device 106 may perform a second transfer initiation action to initiate a second ownership transaction.

In one example implementation, the second user may request the first user to perform an additional verification using the first fingerprint of the first ownership document. The first user device 104 may initially share a second encrypted first fingerprint with the second user device 106, obtained by encrypting a second encoded first fingerprint using a second private key of the first user. The first user device 104 may further request the asset management device 210 to share a verification fingerprint of the first ownership document with the second user device 106. The second user device 106 may then compare an encoded verification fingerprint with the second encoded first fingerprint to verify whether the encoded verification fingerprint matches with the second encoded first fingerprint, for completing the additional verification.

In one example implementation, the first user and the second user may complete the second ownership transaction, without involving the asset regulator by using the first ownership document and the first fingerprint generated by the asset regulator. In said example implementation, the first user device 104 may share the first ownership document and the first fingerprint with the second user device 106. The second user device 106 may then generate a second ownership locking script having a public key of the second user and another encoded first fingerprint. The first user device 104 may then use the second ownership locking script for creating the second ownership transaction to complete the ownership transfer. The asset management system 204 may subsequently inform the network nodes 216 of the public ledger network 206 for adding the second ownership transaction in the public ledger after verification.

In another example implementation, the first user and the second user may approach the asset regulator for completing and verifying the second ownership transaction. The asset management device 210 may then obtain a second ownership document, indicating the second user as the owner of the asset, and a second fingerprint of the second ownership document. The asset management system 204 may then share an encrypted second fingerprint with the second user to transfer the ownership, The second user device 106 may then decrypt the encrypted second fingerprint to obtain the second fingerprint and generate the second ownership locking script having the public key of the second user and encoded second fingerprint. The first user device 104 may then use the second ownership locking script for creating the second ownership transaction to complete the ownership transfer. The asset management system 204 may subsequently inform the network nodes 216 of the public ledger network 206 for adding the second ownership transaction in the public ledger after verification.

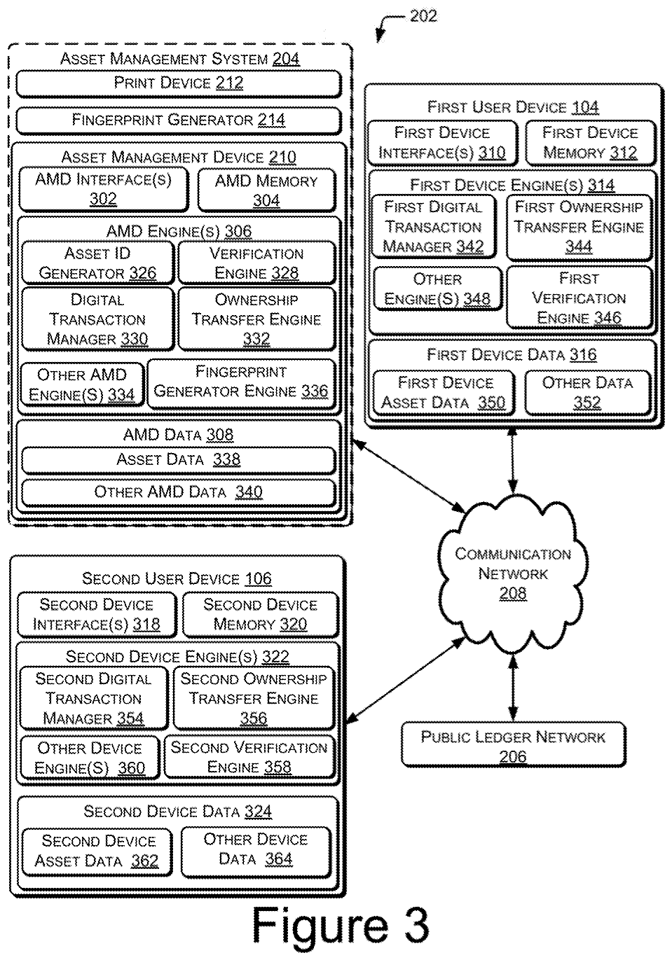

FIG. 3 illustrates a block diagram of the system 102 in communication with the public ledger network 206 for asset ownership transfer and verification management, according to another example of the present subject matter. As previously described, the system 102 may include the asset management system 204 associated with the asset regulator managing the asset. The asset management system 204 may further include the asset management device 210. The system 102 may further include the first user device 104 and the second user device 106 associated with the first user and the second user, respectively. The asset management system 204, the first user device 104, and the second user device 106 may be in communication with each other and the public ledger network 206 over the communication network 208 for transfer and verification of ownership of the asset.

In one example implementation, the asset management device 210, the first user device 104, and the second user device 106 include interface(s), memory, engine(s), and data. The interface(s) may include a variety of interfaces, for example, interfaces for data input and output devices, referred to as I/O devices, storage devices, network devices, and the like. The interface(s) facilitate communication between the asset management device 210, the first user device 104, the second user device 106, the print device 212, the fingerprint generator 214, the network nodes 216, and various other computing devices connected in a networked environment. The interface(s) may also provide a communication pathway for one or more components of the asset management device 210, the first user device 104, and the second user device 106. Examples of such components include, but are not limited to, input device, such as keyboards, computer mice, and a touch enabled graphical user interface.

The memory may store one or more computer-readable instructions, which may be fetched and executed to provide print interfaces to users for providing print instructions. The memory may include any non-transitory computer-readable medium including, for example, volatile memory such as RAM, or non-volatile memory such as EPROM, flash memory, and the like.

The engine(s) may be implemented as a combination of hardware and programming (for example, programmable instructions) to implement one or more functionalities of the engine(s). In examples described herein, such combinations of hardware and programming may be implemented in several different ways. For example, the programming for the engine(s) may be processor executable instructions stored on a non-transitory machine-readable storage medium and the hardware for the engine(s) may include a processing resource (for example, one or more processors), to execute such instructions. In the present examples, the machine-readable storage medium may store instructions that, when executed by the processing resource, implement engine(s). In such examples, the print device may include the machine-readable storage medium storing the instructions and the processing resource to execute the instructions, or the machine-readable storage medium may be separate but accessible to the print device and the processing resource. In other examples, engine(s) may be implemented by electronic circuitry. The data includes data that is either stored or generated as a result of functionalities implemented by any of the engine(s).

For example, the asset management device 210 may include the asset management device (AMD) interface(s) 302, AMD memory 304, AMD engine(s) 306, and AMD data 308. The first user device 104 may include the first device interface(s) 310, first device memory 312, first device engine(s) 314, and first device data 316. The second user device 106 may include the second device interface(s) 318, second device memory 320, second device engine(s) 322, and second device data 324.

The AMD engine(s) 306 of the asset management device 210 include an asset ID generator 326, a verification engine 328, a digital transaction manager 330, an ownership transfer engine 332, other AMD engine(s) 334, and a fingerprint generator engine 336. The other AMD engine(s) 334 may implement functionalities that supplement applications or functions performed by the AMD engine(s) 306. Further, the AMD data 308 may include asset data 338 and other AMD data 340.

The first device engine(s) 314 of the first user device 104 include a first digital transaction manager 342, a first ownership transfer engine 344, a first verification engine 346, and other engine(s) 348. The other engine(s) 348 may implement functionalities that supplement applications or functions performed by the first device engine(s) 314. Further, the first device data 316 may include first device asset data 350 and other data 352.

The second device engine(s) 322 of the second user device 106 include a second digital transaction manager 354, a second ownership transfer engine 356, a second verification engine 358, and other device engine(s) 360. The other device engine(s) 360 may implement functionalities that supplement applications or functions performed by the second device engine(s) 322. Further, the second device data 324 may include second device asset data 362 and other device data 364.

As previously described, the asset regulator may register the asset managed by the asset regulator, with the public ledger using the asset management device 210 of the asset management system 204. In one example, the asset ID generator 326 may initially generate the asset ID of the asset for digital identification of the asset in the public ledger. The asset ID generator 326 may then provide the asset ID to the digital transaction manager 330 for performing the genesis transaction with the public ledger. In one example implementation, the ID generator 326 may share the encoded asset ID with the digital transaction manager 330. In one example, the asset ID generator 326 may perform a hash coding of the asset ID using a hash function to obtain the encoded asset ID. In another example, the asset generator 326 may use another coding technique to obtain the encoded asset ID. In one example, the asset generator 326 may save the asset ID and the encoded asset ID in the asset data 338.

To initiate the genesis transaction, the digital transaction manager 330 may initially perform the initiating transaction by transferring the token from the first digital address associated with the asset regulator to the second digital address associated with the asset regulator in the public ledger. As previously described, the token may be a transaction token, such as a cryptocurrency recognized by the public ledger network. For example, for a blockchain used as the public ledger, the token may be a bitcoin. Similarly, other public ledgers may use other tokens. The digital transaction manager 330 may then record the encoded asset ID of the asset in the genesis transaction while performing the genesis transaction for making the asset available for ownership transfer.

Further, the digital transaction manager 330 may unlock the initiating transaction to obtain a reference transaction for performing the genesis transaction. The digital transaction manager 330 may then create the genesis transaction at the digital address associated with the asset regulator in the public ledger such that the genesis transaction includes the encoded asset ID. In one example, the digital transaction manager 330 may create the genesis transaction using the locking script and a proof of existence, having the encoded asset ID and the public key of the asset regulator. The digital transaction manager 330 may use an exemplary locking script as provided below:
scriptPubKey: OP_HASH160 <Asset_scriptHash> OP_EQUAL
Proof of existence: OP RETURN <hash_AID>
   where, “hash_AID” is the encoded asset ID and “Asset_scriptHash” is the hash of the locking script used by the asset regulator.

Upon creation of the genesis transaction, the digital transaction manager 330 may broadcast a genesis transaction, the creation message to the network nodes 216 for verification and addition in the public ledger at the digital address of the asset regulator in the public ledger.

Subsequently, when the first user intends to obtain the asset from the asset regulator, the first user device 104 may initially perform a verification of the asset regulator's ownership of the asset. The first verification engine 346 of the first user device 104 may generate a verification request for requesting the asset management device 210 to verify the ownership of the asset. The first verification engine 346 may then encrypt the verification request using a private key of the first user to obtain the encrypted verification request and transmit the encrypted verification request to the asset management device 210 to request verification of the asset ownership by the asset regulator.

On receiving the encrypted verification request, the verification engine 328 may decrypt the encrypted verification request using the public key of the first user to obtain the verification request. The verification engine 328 may then encrypt the verification request using a private key of the asset regulator to generate the asset ownership verification message. The verification engine 328 may transmit the asset ownership verification message and the digital address of genesis transaction to the first user device 104, to authenticate ownership of the asset.

Upon receiving the asset ownership verification message and the digital address of genesis transaction, the first verification engine 346 may obtain a public key of the asset regulator using the asset ownership verification message, the verification request, and the digital address shared by the asset regulator. In one example, the first verification engine 346 may use an elliptic curve digital signature algorithm (ECDSA) to process the asset ownership verification message, the verification request, and the digital address to obtain the public key of the asset regulator. Subsequently, the first verification engine 346 may decrypt the asset ownership verification message to obtain an embedded digital address stored in the ownership verification message. in one example, the embedded digital address is the digital address of the genesis transaction. The first verification engine 346 may compare the embedded digital address stored in the asset ownership verification message with the digital address shared by the asset regulator to verify the ownership of the asset and digital address of the asset regulator.

Subsequently, the first digital transaction manager 342 of the first user device 104 may perform the first transfer initiation action for initiating ownership transfer of the asset from the asset regulator to the first user. In one example, the first transfer initiation action may include transferring the token from a first user digital address of the first user to the digital address of the asset regulator. In one example, the first user device 104 may perform the first transfer initiation action over the public ledger managed by the public ledger network 206 and used by the asset regulator for managing the asset.

Further, the digital transaction manager 330 of the asset management device 210 may ascertain the completion of the first transfer initiation action by the first user device 104 and in response, initiate the first ownership transaction. In one example implementation, the fingerprint generator engine 336 of the asset management device 210 may obtain the first fingerprint for being shared with the first user for the ownership transfer. In one example, the fingerprint generator engine 336 may instruct the print device 212 to generate the first ownership document. In response, the print device 212 may generate the first ownership document indicating transfer of ownership of the asset to the first user. In one example, the first ownership document may be printed on a print medium, such as paper, on which colorant, like toner or ink, has been output to form a forensic mark including details of ownership transfer of the asset to the first user.

The fingerprint generator 214 may subsequently generate the first fingerprint using the first ownership document. In one example, the first fingerprint may be a forensic fingerprint obtained using a series of images of the first ownership document. In one example, the images of the first ownership document may be captured using illumination sources and may reflect properties of the first ownership document in 2.5 Dimensions (2.5D) or three dimensions (3D). For example, where the first ownership document is a print medium having a forensic mark formed using the colorant, then at least 2.5D of the first ownership document may include a portion of a 3D microstructure of a surface of the substrate of the print medium on which the colorant has been output. The fingerprint generator 214 may process the series of images to generate the first fingerprint using various forensic signature obtaining approaches, such as a photometric stereoscopic approach and a shape warp code approach.

Further, the ownership transfer engine 332 of the asset management device 204 may encrypt the first fingerprint with a private key of the asset regulator to obtain a secure first fingerprint. The ownership transfer engine 332 may further encrypt the secure first fingerprint using a public key of the first user to obtain an encrypted first fingerprint. The ownership transfer engine 332 may transmit the encrypted first fingerprint to the first user device 104 to initiate the first ownership transaction.

The first ownership transfer engine 344 may decrypt the encrypted first fingerprint received from the asset management device 210, using the private key of the first user to obtain the secure first fingerprint. The first ownership transfer engine 344 may further decrypt the secure first fingerprint using the public key of the asset regulator to obtain the first fingerprint and encode the first fingerprint to obtain the encoded first fingerprint. In one example, the first ownership transfer engine 344 may encode the first fingerprint using a hash function to obtain the encoded first fingerprint. In another example, the first ownership transfer engine 344 may use other coding techniques to obtain the encoded first fingerprint. The first ownership transfer engine 344 may subsequently generate the first ownership locking script for creating the first ownership transaction and share the first ownership locking script with the asset management device 210. in one example, the first ownership locking script may include the public key of the first user and the encoded first fingerprint. In one example, the first ownership transfer engine 344 may save the first fingerprint and the encoded first fingerprint in the first device asset data 350.

The digital transaction manager 330 of the asset management device 210 may create the first ownership transaction. The digital transaction manager 330 may initially unlock the genesis transaction and create the first ownership transaction at the first user digital address associated with the first user. in one example, the first ownership transaction may include the encoded first fingerprint. The digital transaction manager 330 may use the first ownership locking script to create the first ownership transaction. In one example, the digital transaction manager 330 may use an exemplary first ownership locking script as provided below, for the public ledger being a bitcoin based blockchain, the first ownership locking script may vary depending on the public ledger being used:
scriptPubkey: OP_HASH160 <Fingerprint_scriptHash> OP_EQUAL

Further, the digital transaction manager 330 may use an exemplary unlocking script to unlock the genesis transaction, as provided below for the public ledger being a bitcoin based blockchain, the unlocking script may vary depending on the public ledger being used:
scriptSig: <signature> <serialized script>
serialized script: <pubkey_Reg> <hashAID> OP_HASH160 <OP_HASH160(hash_AID)> OP_EQUALVERIFY OP_DUP OP_HASH160 <pubKeyHash_Reg> OP_EQUALVERIFY OP_CHECKSIG
   where, “pubkey_Reg” is the public key of the asset regulator, “hash _AID” is, the encoded asset ID, and “pubKeyHash_Reg” is an encoded public key of the asset regulator.

In one example, the digital transaction manager 330 may broadcast a first ownership transaction creation message to one of the network node 216 of the public ledger network 206 for verification and addition in the public ledger at the first user digital address of the first user in the public ledger.

When the second user intends to obtain the asset from the first user, the second verification engine 358 of the second user device 106 may request the first user for providing details of the first ownership transaction indicating ownership of the asset by the first user. The first ownership transfer engine 344 may then provide the details of the first ownership transaction to the second user device 106. In one example, the details may assist the second verification engine 358 to search for the first ownership transaction in the public ledger and identify the genesis transaction in the public ledger and the encoded asset ID recorded in the genesis transaction.

Upon confirming the asset ID and the genesis transaction, the second verification engine 358 may generate a verification request message for requesting the first user device 104 to verify the ownership of the asset. The second verification engine 358 may then encrypt the verification request message using a private key of the second user to obtain the encrypted verification request message and transmit the encrypted verification request message to the first user device 104 to request verification of the asset ownership by the first user.

On receiving the encrypted verification request message, the first verification engine 346 may decrypt the encrypted verification request message to obtain the verification request message using a public key of the second user. The first verification engine 346 may then encrypt the verification request message using a private key associated with the first user digital address to obtain the ownership verification message. Further the first verification engine 346 may transmit the first user digital address of the first ownership transaction and the ownership verification message to the second user device 106 to authenticate ownership of the asset.

Upon receiving the ownership verification message and the first user digital address of the first ownership transaction, the second user device 106 may obtain a public key of the first user. The second user device 106 may obtain the public key of the first user using the ownership verification message, the verification request message, and the first user digital address shared by the first user. In one example, the second verification engine 358 may use the ECDSA to process the ownership verification message, the verification request message, and the first user digital address to obtain the public key of the first user. Subsequently, the second verification engine 358 may decrypt the ownership verification message to obtain embedded first user digital address stored in the ownership verification message. In one example, the embedded first user digital address is the digital address of the first ownership transaction. The second verification engine 358 may compare the embedded first user digital address stored in the ownership verification message with the first user digital address shared by the first user to verify the ownership of the asset and the first user digital address of the first user.

Further, the second user, in one example implementation, may request the first user to perform an additional verification using the first fingerprint of the first ownership document. In response, the first verification engine 346 of the first user device 104 may encode the first fingerprint, to obtain the second encoded first fingerprint. In one example, the first verification engine 346 may use a coding function, such as a hash function such that second encoded first fingerprint is different from the encoded first fingerprint. The first verification engine 346 may further encrypt the second encoded first fingerprint using the second private key of the first user to generate the second encrypted first fingerprint such that the second encrypted first fingerprint is different from the encrypted first fingerprint. The first verification engine 346 may share the second encrypted first fingerprint with the second user device 106. The first verification engine 346 may further request the asset management device 210 to share the verification fingerprint of the first ownership document, with the second user device 106.

In one example, the fingerprint generator engine 336 of the asset management device 210 may obtain the verification fingerprint from the first ownership document using similar steps as used to obtain the first fingerprint. The second verification engine 358 may then compare the encoded verification fingerprint with the second encoded first fingerprint to verify whether the encoded verification fingerprint matches with the second encoded first fingerprint, for completing the additional verification.

Upon verification, the second digital transaction manager 354 may perform a second transfer initiation action to initiate a second ownership transaction. In one example, the second transfer initiation action may include transferring the token from a second user digital address of the second user to the first user digital address of the first user. In one example, the second digital transaction manager 354 may perform the second transfer initiation action over the public ledger managed by the public ledger network 206 and used by the asset regulator for managing the asset.

Further, as previously described, in one example implementation, the first user and the second user may complete the second ownership transaction without involving the asset regulator by using the first ownership document and the first fingerprint generated by the asset regulator. The first ownership transfer engine 344 may thus share the first ownership document and the first fingerprint with the second user device 106. The second ownership transfer engine 356 of the second user device 106 may then generate the second ownership locking script having the public key of the second user and another encoded first fingerprint.

In case the first user and the second user approach the asset regulator for completing and verifying the second, ownership transaction, the fingerprint generator engine 336 may obtain the second ownership document, indicating the second user as the owner of the asset, and the second fingerprint of the second ownership document. In one example, the second ownership document and the second fingerprint may be generated by the print device 212 and the fingerprint generator 214 using the same method and techniques as used for obtaining the first ownership document and the first fingerprint, as described above.

The ownership transfer engine 332 may further encrypt the second fingerprint with the private key of the asset regulator to obtain a secure second fingerprint. The ownership transfer engine 332 may further encrypt the secure second fingerprint using the public key of the second user to obtain the encrypted second fingerprint. The ownership transfer engine 332 may then transmit the encrypted second fingerprint to the second user device 106. The second ownership transfer engine 356 may then decrypt the encrypted second fingerprint using the private key of the second user to obtain the secure second fingerprint. The second ownership transfer engine 356 may further decrypt the secure second fingerprint using the public key of the asset regulator to obtain the second fingerprint. Further, the second ownership transfer engine 356 may generate the second ownership locking script for creating the second ownership transaction. In one example, the second ownership locking script includes the public key of the second user and the encoded second fingerprint. In one example, the second ownership transfer engine 356 may save the second fingerprint and the encoded second fingerprint in the second device asset data 362.

Subsequently, the first digital transaction manager 342 of the first user device 104 may create the second ownership transaction in the public ledger. The first digital transaction manager 342 may unlock the first ownership transaction to create the second ownership transaction at the second user digital address of the second user. In one example, the first digital transaction manager 342 may use an exemplary second unlocking script to unlock the first ownership transaction, as provided below for the public ledger being a bitcoin based blockchain, the second unlocking script may vary depending on the public ledger being used:
scriptSig: <signature> <serialized script>
serialized script: <pubkey_first user> <hash_FP1>OP_HASH160 <OP_HASH160(hash_FP1)> OP_EQUALVERIFY OP_DUP OP_HASH160 <pubkeyHash_first user> OP_EQUALVERIFY OP_CHECKSIG
   where, pubkey_first user is the public key of the first user, “hash_FP1” is the encoded first fingerprint, and “pubKeyHash_first user” is the encoded public key of the first user.

Further, the first digital transaction manager 342 may use the second ownership locking script to create the second ownership transaction. In one example, the second ownership transaction may include the encoded second fingerprint. Further, the first digital transaction manager 342 may use an exemplary second ownership locking script as provided below for the public ledger being a bitcoin based blockchain, the second ownership locking script may vary depending on the public ledger being used:
scriptPubKey: OP_HASH160 <Fingerprint_scriptHash> OP_EQUAL

Further, the first digital transaction manager 342 may broadcast a second ownership transaction creation message to one of the network node 216 of the public ledger network 206 for verification and addition in the public ledger at the second user digital address of the second user in the public ledger.

Further, when a prospective owner wishes to obtain the asset, the second user and the prospective owner may perform the ownership verification and transfer steps and techniques as described above in reference to the first user and the second user.

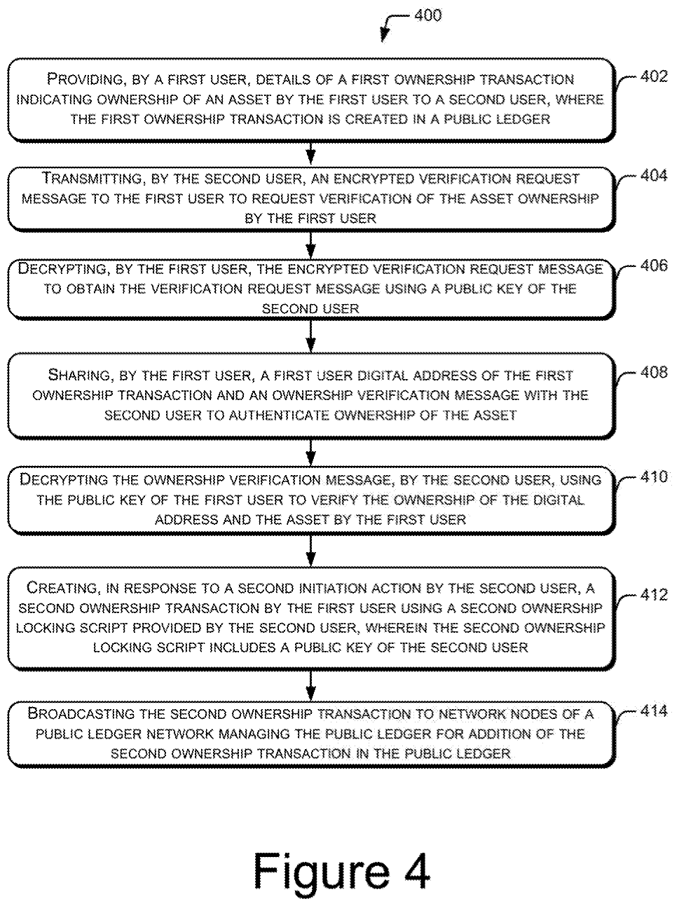

FIGS. 4-6 illustrate example methods 400, 500, and 600, respectively, for asset ownership transfer and verification management. The order in which the methods are described is not intended to be construed as a limitation, and any number of the described method blocks may be combined in any order to implement the methods, or an alternative method. It may also be understood that methods 400, 500, and 600 may be performed by an asset management system, a first user device, a second user device, and a public ledger network as depicted in FIGS. 1-3. While the methods 400, 500, and 600 are described below with reference to the asset management system, the first user device, the second user device, and the public ledger network, other suitable systems for the execution of these methods may also be utilized. Additionally, implementation of these methods is not limited to such examples.

FIG. 4 illustrates the method 400 of asset ownership transfer and verification management, according to an example of the present subject matter. At block 402, details of a first ownership transaction indicating ownership of an asset by a first user are provided by the first user to a second user. In one example, the first ownership transaction is created in a public ledger hosted by a public ledger network, such as the public ledger network 206. In one example, the first user is a first owner of the asset managed by an asset regulator. Further, the second user is a prospective second owner of the asset owned by the first user.

At block 404, an encrypted verification request message is transmitted to the first user by the second user, to request verification of the asset ownership by the first user. In one example, a second user of the second user device may generate a verification request message and encrypt the verification request message to obtain the verification request message.

At block 406, the encrypted verification request message is decrypted by the first user to obtain the verification request message using a public key of the second user.

At block 408, a first user digital address of the first ownership transaction and an ownership verification message is shared, by the first user, with the second user to authenticate ownership of the asset. In one example, the ownership verification message is generated by encrypting the verification request message using a private key associated with the first user digital address.

At block 410, the ownership verification message is decrypted by the second user using the public key of the first user to verify the ownership of the first user digital address and the asset by the first user.

At block 412, a second ownership transaction is created by the first user, in response to a second initiation action by the second user. In one example, the first user may use a second ownership locking script provided by the second user to create the second ownership transaction such that the second ownership locking script includes a public key of the second user.

At block 414, the second ownership transaction broadcasted to the network nodes of a public ledger network managing the public ledger. In one example, a digital transaction manager of the first user device may broadcast a second ownership transaction creation message to the network nodes for verification and addition of the second ownership transaction in the public ledger.

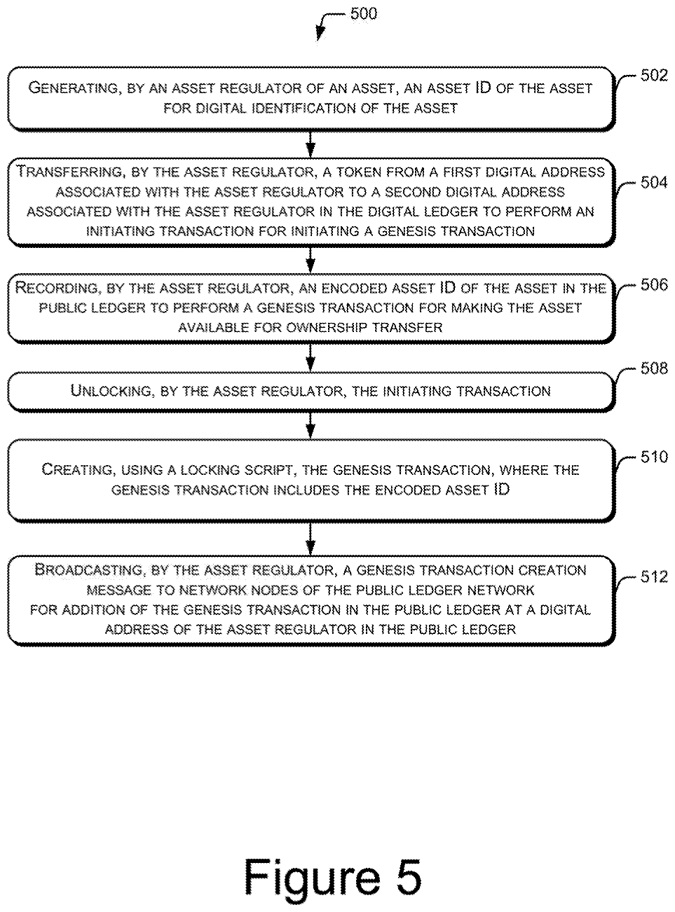

FIG. 5 illustrates the method 500 of asset ownership transfer and verification management, according to another example of the present subject matter. At block 502, an asset ID of an asset is generated by an asset regulator of the asset. In one example, the asset regulator may use an asset ID generator to obtain the asset ID. The asset ID may be utilized by the asset regulator for digital identification of the asset in a public ledger used by the asset regulator for asset ownership transfer and verification management.

At block 504, a token is transferred from a first digital address associated with the asset regulator to a second digital address associated with the asset regulator in the digital ledger. In one example, a digital transaction manager of an asset management device of the asset regulator may transfer the token to perform an initiating transaction for initiating a genesis transaction for registering the asset with the public ledger.

At block 506, an encoded asset ID of the asset is recorded by the asset regulator in the public ledger to perform a genesis transaction for making the asset available for ownership transfer.

At block 508, the initiating transaction is unlocked by the asset regulator to obtain a reference transaction for creating the genesis transaction in the public ledger.

At block 510, the genesis transaction is created by the asset regulator. In one example, the genesis transaction may include the encoded asset ID. Further, the genesis transaction may be created using a locking script having the encoded asset ID and public key of the asset regulator.

At block 512, a genesis transaction creation message is broadcasted by the asset regulator to a network node of a public ledger network hosting the public ledger where the asset is registered. In one example, the genesis transaction is transmitted for verification and addition in the public ledger at the digital address of the asset regulator in the public ledger. The network nodes of the public ledger network may verify the genesis transaction using verification techniques and methods implemented by the public ledger network.

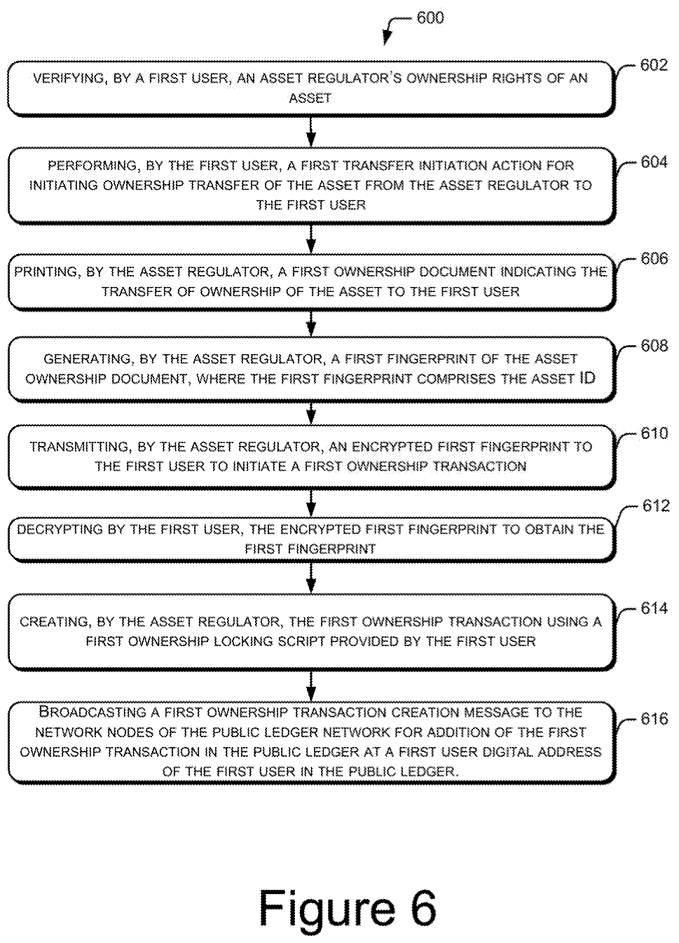

FIG. 6 illustrates the method 600 of asset ownership transfer and verification management, according to another example of the present subject matter. At block 602, an asset regulator's ownership rights of an asset are verified by a first user. In one example, to verify the asset regulator's ownership rights, the first user may verify a digital, address of the asset regulator using the asset ownership verification message, the digital address, and the verification request.

At block 604, the first user may perform a first transfer initiation action. In one example, upon verification of the asset regulator's ownership rights of the asset, the first user may perform the first transfer initiation action for initiating ownership transfer of the asset from the asset regulator to the first user.

At block 606, a first ownership document is printed by the asset regulator. In one example, the first ownership document may indicate the transfer of ownership of the asset from the asset regulator to the first user. In one example implementation, the asset regulator may print the first ownership document using a print device and an asset management device, such as the print device 212 and the asset management device 210.

At block 608, a first fingerprint of the first ownership document is generated by the asset regulator. in one example, the first fingerprint comprises the asset ID. Further, in one example implementation, the asset regulator may generate the first fingerprint of the first ownership document using a fingerprint generator and an asset management device, such as the fingerprint generator 214 and the asset management device 210.

At block 610, an encrypted first fingerprint is transmitted by the asset regulator to the first user to initiate a first ownership transaction for transferring the ownership of the asset to the first user. In one example, the asset regulator may initially encrypt the first fingerprint with a private key of the asset regulator to obtain a secure first fingerprint. The asset regulator may further encrypt the secure first, fingerprint using a public key of the first user to obtain an encrypted first fingerprint.

At block 612, the encrypted first fingerprint is decrypted by the first user to obtain the first fingerprint. In one example, the first user may decrypt the encrypted first fingerprint using the private key of the first user to obtain the secure first fingerprint. The first user may further decrypt the secure first fingerprint using the public key of the asset regulator to obtain the first fingerprint and encode the first fingerprint to obtain an encoded first fingerprint.

At block 614, the first ownership transaction is created by the asset regulator in the public ledger using a first ownership locking script provided by the first user. In one example, the first ownership locking script includes a public key of the first user and the encoded first fingerprint.

At block 616, a first ownership transaction creation message is broadcasted to network nodes of the public ledger network. in one example, the asset regulator may broadcast the first ownership transaction for addition in the public ledger at the first user digital address of the first user in the public ledger. The network nodes of the public ledger network may further verify the first ownership transaction using verification techniques and methods implemented by the public ledger network.

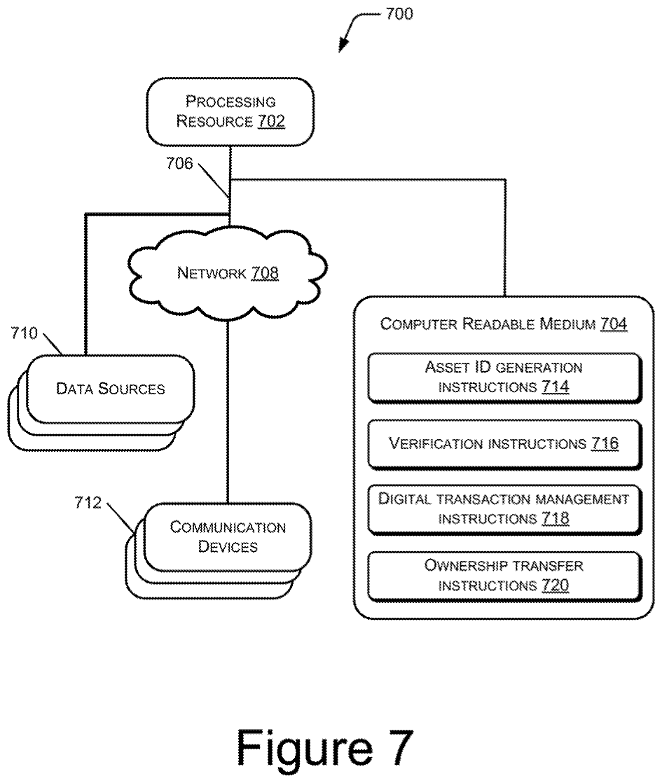

FIG. 7 illustrates a network environment 700 implementing a non-transitory computer readable medium for asset ownership transfer and verification management, according to an example of the present subject matter. The network environment 700 may comprise at least a portion of a public networking environment or a private networking environment, or a combination thereof. In one implementation, the network environment 700 includes a processing resource 702 communicatively coupled to a computer readable medium 704 through a communication link 706.

For example, the processing resource 702 can include processors of a computing device for asset ownership transfer and verification management. The computer readable medium 704 can be, for example, an internal memory device of the computing device or an external memory device. In one implementation, the communication link 706 may be a direct communication link, such as any memory read/write interface. In another implementation, the communication link 706 may be an indirect communication link, such as a network interface. In such a case, the processing resource 702 can access the computer readable medium 704 through a network 708. The network 708 may be a single network or a combination of multiple networks and may use a variety of different communication protocols.

The processing resource 702 and the computer readable medium 704 may also be coupled to requested data sources 710 through the communication link 706, and/or to communication devices 712 over the network 708. The coupling with the requested data sources 710 enables in receiving the requested data in an offline environment, and the coupling with the communication devices 712 enables in receiving the requested data in an online environment.

In one implementation, the computer readable medium 704 includes a set of computer readable instructions, implementing asset ID generation instructions 714, verification instructions 716, digital transaction management instructions 718, and ownership transfer instructions 720. The set of computer readable instructions can be accessed by the processing resource 702 through the communication link 706 and subsequently executed to process requested data communicated with the requested data sources 710 in order to facilitate asset ownership transfer and verification management in a thin provisioned virtual environment. When executed by the processing resource 702, the asset ID generation instructions 714 may cause the processing resource 702 to perform the functionalities described above in relation to the asset ID generator 326. When executed by the processing resource 702, the verification instructions 716 may cause the processing resource 702 to perform the functionalities described above in relation to the verification engine 328. When executed by the processing resource 702, the digital transaction management instructions 718 may cause the processing resource 702 to perform the functionalities described above in relation to the digital transaction manager 330. When executed by the processing resource 702, the ownership transfer instructions 720 may cause the processing resource 702 to perform the functionalities described above in relation to the ownership transfer engine 332.

For example, the asset ID generation instructions 714, may cause the processing resource 702 to perform a genesis transaction for managing ownership transfer of the asset. In one example, the asset ID generation instructions 714, may cause the processing resource 702 to include an encoded asset ID of the asset in the genesis transaction. Further, the verification instructions 716 may cause the processing resource 702 to send an asset ownership verification message to a first user device of a first user to authenticate ownership of the asset, in response to an encrypted verification request received from the first user device. In one example, the asset ownership verification message is obtained by decrypting the encrypted verification request and encrypting the verification request using a private key of the asset regulator.

Further, the digital transaction management instructions 718 may cause the processing resource 702 to ascertain completion of a first transfer initiation action by the first user device for initiating transfer of ownership of the asset from the asset regulator to the first user. In one example, the first user device may perform the first transfer initiation action after verification of the asset ownership of the asset regulator. The first user device may perform the first transfer initiation action over a public ledger hosted by a public ledger network in communication with the network environment 700.

Subsequently, the ownership transfer instructions 720 may cause the processing resource 702 to transmit a first fingerprint of a first ownership document to the first user to transfer the ownership of the asset to the first user. In one example, the first ownership document indicates the first user as the owner of the asset and the fingerprint comprises the asset ID.

Further, the digital transaction management instructions 718 may cause the processing resource 702 to create a first ownership transaction using a first ownership locking script provided by the first user device. In one example, the first ownership locking script includes a public key of the first user and an encoded first fingerprint. The digital transaction management instructions 718 may further cause the processing resource 702 to broadcast the first ownership transaction to network nodes of a public ledger network for verification and addition of the first ownership transaction in the public ledger at a first user digital address corresponding to the first user.

Although examples for the present subject matter have been described in language specific to structural features and/or methods, it should be understood that the appended claims are not limited to the specific features or methods described. Rather, the specific features and methods are disclosed and explained as examples of the present subject matter.

I/We claim:

1. A system comprising:
a second user device of a second user, wherein the second user is a prospective second owner of an asset owned by a first user, the second user device is to:
receive, from a first user device of the first user, an ownership verification message and a first user digital address of a first, ownership transaction to authenticate ownership of the asset by the first user, wherein the first ownership transaction is created in a public ledger for managing ownership verification and transfer; and
upon verification of the ownership of the first user digital address and the asset, perform a second transfer initiation action for initiating transfer of ownership of the asset from the first user to the second user
encode a second fingerprint, received from an asset regulator, to obtain an encoded second fingerprint, wherein the second fingerprint is obtained from a second ownership document indicating a transfer of ownership of the asset to the second user from the first user; and
the first user device of the first user, wherein the first user is a first owner of the asset managed by the asset regulator, the first user device is to create a second ownership transaction using a second ownership locking script, wherein the second ownership locking script includes a public key of the second user and the encoded second fingerprint.

2. The system as claimed in claim 1, wherein the second user, device further is to:
transmit an encrypted verification request message to the first user device to request verification of the asset ownership by the first user:
upon receiving the ownership verification message, obtain a public key of the first user using the ownership verification message, a verification request message, and the first user digital address for verifying the ownership of the asset and the first user digital address:
decrypt an encrypted second fingerprint received from an asset management system, using the private key of the second user to obtain a secure second fingerprint, wherein the asset management system is associated with the asset regulator for regulating ownership transfer and verification of the asset;
decrypt the secure second fingerprint using a public key of the asset regulator to obtain the second fingerprint; and
generate the second ownership locking script for creating the second ownership transaction.

3. The system as claimed in claim 2, wherein the first user device further is to:
provide details of the first ownership transaction indicating ownership of the asset by the first user to the second user device;
decrypt the encrypted verification request message to obtain a verification request message using a public key of the second user;
transmit the first user digital address of the first ownership transaction and the ownership verification message to the second user to authenticate ownership of the asset, wherein the ownership verification message is generated by encrypting the verification request message using a private key associated with the first user digital address; and
broadcast creation of the second ownership transaction to network nodes of a public ledger network managing the public ledger, for adding the second ownership transaction in the public ledger.

4. The system as claimed in claim 2, wherein the system further comprises:
a print device to print the second ownership document indicating the transfer of ownership of the asset to the second user, wherein the second ownership document indicates the second user as the owner of the asset;
a fingerprint generator to generate the second fingerprint of the second ownership document, wherein the second fingerprint comprises the asset ID; and
an asset management device to;
encrypt the second fingerprint with a private key of the asset regulator to obtain the secure second fingerprint;
encrypt the secure second fingerprint using a public key of the second user to obtain the encrypted second fingerprint;
transmit the encrypted second fingerprint to the second user device to initiate the second ownership transaction.

5. The system as claimed in claim 4, wherein the asset management device further is to:
generate the asset ID of the asset using an asset ID generator for digital identification of the asset;
transfer a token from a first digital address associated with the asset regulator to a second digital address associated with the asset regulator in the public ledger to perform an initiating transaction for initiating the genesis transaction;
perform a genesis transaction for making the asset available for ownership transfer, wherein the genesis transaction includes an encoded asset ID of the asset;
unlock the initiating transaction;
create, using a locking script, the genesis transaction at digital address associated with the asset regulator in the public ledger, wherein the locking script includes the encoded asset ID and a public key of the asset regulator, and wherein the genesis transaction includes the encoded asset ID;
broadcast a genesis transaction creation message to network nodes of the public ledger network for verification and addition in the public ledger at the digital address of the asset regulator in the public ledger;
receive, from the first user device, an encrypted verification request to request verification of the asset ownership by the asset regulator;
decrypt the encrypted verification request using a public key of the first user to obtain the verification request
encrypt the verification request using a private key of the asset regulator to generate an asset ownership verification message;
transmit to the first user device, the asset ownership verification message and the digital address of genesis transaction to authenticate ownership of the asset;
ascertain completion of a first transfer initiation action by the first user device for initiating transfer of ownership of the asset from the asset regulator to the first user;
encrypt a first fingerprint with the private key of the asset regulator to obtain a secure first fingerprint, wherein the first fingerprint is obtained from a first ownership document indicating a transfer of ownership of the asset to the first user from the asset regulator;
encrypt the secure first fingerprint using the public key of the first user to obtain an encrypted first fingerprint;
transmit the encrypted first fingerprint to the first user device to initiate the first ownership transaction; and
create the first ownership transaction using a first ownership locking script provided by the first user device, wherein the first ownership locking script includes the public key of the first user and an encoded first fingerprint.

6. The system as claimed in claim 5, wherein the first user device further is to:
transmit the encrypted verification request to the asset management device to request verification of the asset ownership by the asset regulator;
receive the asset ownership verification message and the digital address of genesis transaction from the asset management device in response to the encrypted verification request;
obtain a public key of the asset regulator using the asset ownership verification message, the verification request, and the digital address shared by the asset regulator;
decrypt the asset ownership verification message to obtain an embedded digital address stored in the ownership verification message, wherein the embedded digital address is the digital address of the genesis transaction;
compare the embedded digital address stored in the asset ownership verification message with the digital address shared by the asset regulator to verify the ownership of the asset and digital address of the asset regulator;
perform the first transfer initiation action for initiating ownership transfer of the asset from the asset regulator to the first user;
decrypt the encrypted first fingerprint received from the asset management device, using the private key of the first user to obtain the secure first fingerprint;
decrypt the secure first fingerprint using the public key of the asset regulator to obtain the first fingerprint;
encode the first fingerprint to obtain the encoded first fingerprint; and
generate the first ownership locking script for creating the first ownership transaction.

7. A method for managing ownership transfer of an asset comprising:
providing, by a first user, details of a first ownership transaction indicating ownership of an asset by the first user to a second user, wherein the first ownership transaction is created in a public ledger;
transmitting, by the second user, an encrypted verification request message to the first user to request verification of the asset ownership by the first user;
decrypting, by the first user, the encrypted verification request message to obtain the verification request message using a public key of the second user;
sharing, by the first user, a first user digital address of the first ownership transaction and an ownership verification message with the second user to authenticate ownership of the asset, wherein the ownership verification message is generated by encrypting the verification request message using a private key associated with the first user digital address;
decrypting the ownership verification message, by the second user, using the public key of the first user to verify the ownership of the first user digital address and the asset by the first user;
creating, in response to a second initiation action by the second user, a second ownership transaction, by the first user, using a second ownership locking script provided by the second user, wherein the second ownership locking script includes the public key of the second user; and
broadcasting the second ownership transaction to network nodes of a public ledger network managing the public ledger for addition of the second ownership transaction in the public ledger.

8. The method as claimed in claim 7, further comprising:
in response to performing the second transfer initiation action by the second user, obtaining, by an asset regulator, a second ownership document indicating the transfer of ownership of the asset to the second user from the first user;
generating, by the asset regulator, a second fingerprint of the second ownership document, wherein the second fingerprint comprises the asset. ID of the asset used to represent the asset in the public ledger;
encrypting, by the asset regulator, the second fingerprint with a private key of the asset regulator to obtain a secure second fingerprint;
encrypting, by the asset regulator, the secure second fingerprint using a public key of the second user to obtain an encrypted second fingerprint;
transmitting, by the asset regulator, the encrypted second fingerprint to the second user to initiate the second ownership transaction; and
decrypting, by the second user, the encrypted second fingerprint to obtain the second fingerprint;
encoding, by the second user, the second fingerprint to obtain an encoded second fingerprint; and
generating, by the second user, the second ownership locking script for creating the second ownership transaction, wherein the second ownership locking script includes the public key of the second user and the encoded second fingerprint.

9. The method as claimed in claim 7, further comprising:
generating, by an asset regulator of the asset, an asset ID of the asset for digital identification of the asset;
transferring, by the asset regulator, a token from a first digital address associated with the asset regulator to a second digital address associated with the asset regulator in the digital ledger to perform an initiating transaction for initiating a genesis transaction;
recording, by the asset regulator, an encoded asset ID of the asset in the public ledger to perform a genesis transaction for making the asset available for ownership transfer;
unlocking, by the asset regulator, the initiating transaction;
creating, using a locking script, the genesis transaction, wherein the locking script includes the encoded asset ID and public key of the asset regulator, and wherein the genesis transaction includes the encoded asset. ID; and
broadcasting, by the asset regulator, a genesis transaction creation message to network nodes of the public ledger network, for addition in the public ledger at a digital address of the asset regulator in the public ledger.

10. The method as claimed in claim 9, further comprising:
transmitting, by the first user an encrypted verification request to the asset regulator to request verification of the asset ownership by the asset regulator;
decrypting, by the asset regulator, the encrypted verification request using, a public key of the first user to obtain the verification request;
encrypting, by the asset regulator, the verification request using a private key of the asset regulator to generate an asset ownership verification message;
transmitting to the first user, the asset ownership verification message and the digital address of genesis transaction to authenticate ownership of the asset;
verifying, by the first user, the ownership of the digital address using the asset ownership verification message, the digital address, and the verification request; and
performing, by the first user, the first transfer initiation action for initiating ownership transfer of the asset from the asset regulator to the first user.

11. The method as claimed in claim 10, further comprising:
printing, by the asset regulator, a first ownership, document indicating the transfer of ownership of the asset to the first user;
generating, by the asset regulator, a first fingerprint of the first ownership document, wherein the first fingerprint comprises the asset ID;
transmitting, by the asset regulator, an encrypted first fingerprint to the first user to initiate the first ownership transaction;
decrypting, by the first user, the encrypted first fingerprint to obtain the first fingerprint;
creating, by the asset regulator, the first ownership transaction using a first ownership locking script provided by the first user, wherein the first ownership locking script includes the public key of the first user and an encoded first fingerprint; and
broadcasting a first ownership transaction creation message to the network nodes of the public ledger network for addition of the first ownership transaction in the public ledger at the first user digital address of the first user in the public ledger.

12. A non-transitory computer readable medium having a set of computer readable instructions that, when executed, cause a processor to:
perform a genesis transaction for managing ownership transfer of an asset, wherein the genesis transaction includes an encoded asset ID of the asset;
in response to an encrypted verification request received from a first user device of a first user, send an asset ownership verification message to the first user device to authenticate ownership of the asset, wherein the asset ownership verification message is obtained by decrypting the encrypted verification request and encrypting the verification request using a private key of the asset regulator;
ascertain completion of a first transfer initiation action by the first user device for initiating transfer of ownership of the asset from the asset regulator to the first user;
transmit a first fingerprint of a first ownership document to the first user to transfer the ownership of the asset to the first user, wherein the first ownership document indicates the first user as the owner of the asset, and wherein the fingerprint comprises the asset ID; and
create a first ownership transaction using a first ownership locking script provided by the first user device, wherein the first ownership locking script includes a public key of the first user and an encoded first fingerprint; and
broadcast the first ownership transaction for addition in a public ledger at a first user address corresponding to the first user.

13. The computer readable medium as claimed in claim 12, wherein the computer readable instructions, when executed, further cause the processor to,
generate the asset ID of the asset using an asset ID generator for digital identification of the asset;
transfer a token from a first digital address associated with the asset regulator to a second digital address associated with the asset regulator in the digital ledger to perform an initiating transaction for initiating a genesis transaction;
unlock the initiating transaction;
create, using a locking script, the genesis transaction, wherein the locking script includes the encoded asset ID and public key of the asset regulator, and wherein the genesis transaction includes the encoded asset ID; and
broadcasting a genesis transaction creation message to network nodes of the public ledger network for verification and addition of the genesis transaction in the public ledger at a digital address of the asset regulator in the public ledger.

14. The computer readable medium as claimed in claim 12, wherein the computer readable instructions, when executed, further cause the processor to,
ascertaining completion of a second transfer initiation action by a second user device of a second user, wherein the second user is a prospective second owner of the asset from the first user;
obtaining a second ownership document indicating the transfer of ownership of the asset to the second user device from the first user;
generating a second fingerprint, using a fingerprint generator, of the second ownership document, wherein the second fingerprint comprises the asset ID of the asset used to represent the asset in the public ledger;
transmitting an encrypted second fingerprint to the second user device to initiate the second ownership transaction.

15. The computer readable medium as claimed in claim 12, wherein the computer readable instructions, when executed, further cause the processor to,
receiving, from the first user device, the encrypted verification request to request verification of the asset ownership by the asset regulator:
decrypting the encrypted verification request using the public key of the first user to obtain the verification request: and
encrypting the verification request using the private key of the asset regulator to generate the asset ownership verification message.
